(19) United States
(12) Patent Application Publication
(10) Pub. No.: US 2008/0273527 A1
(43) Pub. Date: Nov. 6, 2008

(54) Distributed system

(75) Inventors: Michael John Short, Leicester (GB); Michael Joseph Pont, Great Dalby (GB)

Correspondence Address: GOODWIN PROCTER LLP;PATENT ADMINISTRATOR, EXCHANGE PLACE, BOSTON, MA, 02109-2881, US

(73) Assignee: The University of Leicester

(21) Appl. No.: 11/800,046

(22) Filed: May 3, 2007

(51) Int. Cl. H04L 12/40; H04J 3/02

(52) U.S. Cl. 370/364

(57) ABSTRACT

A distributed system comprises a master node, at least one slave node, and two or more communication channels linking the master node to the at least one slave node. The master node is configured for transmitting the same message to the at least one slave node over each of the two or more communication channels, with a pre-determined delay between each channel transmission. In some embodiments, the system may also include a clock synchronization means configured such that the operation of each slave node is synchronized with the master node and/or a different slave node, irrespective of which channel transmission the slave node receives.

### FIELD OF THE INVENTION

The invention relates to a distributed system. Particularly, but not exclusively, the invention relates to a distributed system and a method of communication therein, that is suitable for use in time-triggered applications.

### BACKGROUND OF THE INVENTION

Embedded processors are ubiquitous: they form a core component of a vast range of everyday items (cars, aircraft, medical equipment, factory systems, mobile phones, DVD players, music players, microwave ovens, toys etc). In some cases several embedded processors may be employed, each for a specific function. For example, a typical modern car may contain around fifty embedded processors.

In applications involving multiple processors where predictable behaviour is an important consideration—such as in automotive systems, aerospace systems, medical systems, industrial systems, and in many brown goods and white goods—it is desirable for the processors to communicate with each other in a highly reliable manner. Otherwise, faults that occur in the system may lead to unpredictable behaviour with potentially dangerous consequences.

For example, the Controller Area Network (CAN) protocol is a broadcast, differential serial bus standard that was originally introduced for communication in automotive applications but is now also widely used in process control and many other industrial areas.

In comparison with earlier protocols (and standards such as “RS-485”), CAN is relatively easy to use and provides more hardware support for error detection and recovery. As a consequence of its popularity and widespread use, most modern microcontroller families now have one or more members with on-chip hardware support for this protocol. This means, in turn, that CAN networks can now be implemented at very low cost.

However, from the perspective of a developer of low-cost, high-reliability systems, it may be argued that CAN has five main limitations: [i] Lack of support for time-triggered communications; [ii] Incomplete support for reliable group communications; [iii] Lack of support for redundant bus arrangements; [iv] Lack of mechanisms to handle “babbling idiot” errors (i.e. where a faulty node unduly monopolizes the bus); and [v] Limited bandwidth.

It is important to note that CAN was introduced as a “single bus” protocol to support event-triggered, as opposed to time-triggered, communication. Any distributed system based on a single bus is vulnerable to a range of failures that may result from cable damage, connector damage or electrical interference. Accordingly, many current microcontroller families provide dual on-chip CAN controllers to support more than one communication channel. However, most high-level protocols that are built on CAN do not directly support these additional channels.

Moreover, even where systems support replicated channels, faults may occur across all channels at the same time, for example due to electrical interference. Thus, the provision of replicated channels in itself does not ensure reliable communication.

Furthermore, CAN-based systems are not fully deterministic since jitter (i.e. the time variation between clock ticks) and latency (i.e. the delay between initiation of an event and the event taking place) become unpredictable as load on the bus increases. These systems also have no direct support for a global clock. Consequently, message order on duplicated channels is not identical and so the system cannot be ‘replica determinate’.

Many existing CAN-based protocols rely on media redundancy (i.e. forming a backup path when part of a network becomes unavailable), as opposed to full channel redundancy (i.e. providing replica channels). Media redundancy requires the use of potentially costly dedicated interface electronics. The problems of using traditional full channel redundancy are highlighted above. In addition, in systems where full channel redundancy has been employed it has either required the use of dedicated hardware, which is costly, or it has resulted in limited design scope in the resulting system architecture, with significant levels of clock jitter.

It is therefore an object of the present invention to provide a solution that ameliorates at least some of the aforementioned problems, in CAN and other protocols.

### BRIEF SUMMARY OF THE INVENTION

According to a first aspect of the present invention there is provided a distributed system comprising a master node; at least one slave node; and two or more communication channels linking the master node to the at least one slave node; wherein the master node is configured for transmitting the same message to the at least one slave node over each of the two or more communication channels, with a pre-determined delay between each channel transmission.

According to a second aspect of the present invention there is provided a method of communication in a distributed system comprising the following steps:
(i) transmitting a message from a master node to at least one slave node, over a first communication channel;
(ii) after a pre-determined delay, transmitting the message from the master node to the at least one slave node, over a different communication channel; and
(iii) repeating step (ii) until the message has been sent over a pre-determined number of communication channels.

The present invention advantageously provides for fault-tolerant communication. It provides a low-cost redundancy-management scheme that can be employed to reduce or eliminate the errors generated (for example, due to noise) in a communication system by transmitting the same message over multiple channels with a delay between each individual channel transmission. A fault or failure occurring at a particular point in time across all channels (i.e. brief electromagnetic interference) will therefore affect different parts of each message transmission and so will be unlikely to result in all messages being corrupted. In addition, a fault or failure on one or more channels will not affect the message transmission on another channel and so the integrity of the system will be maintained. The above system can be implemented without the need for expensive or proprietary interface electronics and so may be relatively cheap to install.

The invention, when used with duplicated channels in the manner described, increases the hardware reliability of the communication sub-systems whilst also decreasing the probability of inconsistent message deliveries to acceptable levels for a wide range of embedded systems.

Overall, the invention allows the creation of a reliable, low-cost (and resource constrained) distributed system.

It will be understood, that although significant advantages arise from the use of just two communication channels, the robustness of the system will increase as the number of channels is increased.

The pre-determined delay may be set to provide the same delay before each channel transmission or the delays may be different. The duration of each delay may take into account the routing of the communication channel and differences in the lengths of the communication channels.

Each communication channel advantageously incorporates broadcast bus architecture.

It is desirable that each communication channel be electrically isolated and routed via different physical paths.

Where more that one slave node is employed, Time Division Multiple Access (TDMA) messaging can be employed such that each message is divided into a number of timeslots, with each slave node being allocated a timeslot for carrying a message specifically for it. Thus, each slave will be configured for reading and/or writing a message in its own particular timeslot. Accordingly, since each message transmission is delayed slightly, an error occurring at a particular point in time across two or more channels (i.e. due to interference) may affect different parts of each transmission and therefore affect different timeslots and the messages for different nodes. Consequently, it is likely that each node will receive a message transmission from at least one communication channel in which its particular timeslot/message is unaffected by the error.

In a preferred embodiment, the distributed system further comprises a synchronization means configured such that the operation of each slave node is synchronized with the master node and/or a different slave node, irrespective of which message transmission the slave node receives. This embodiment, can help to ensure that clock synchronization and/or synchronized task execution is robust to failures in the underlying communication channels.

The transmitted messages may each include a time-reference signal to indicate its time delay relative to the first channel transmission of the message.

In one embodiment, the master node may include a master clock, and each of the slave nodes may include a slave clock that is driven by and synchronized with the master clock.

The slave nodes may be configured to wait a pre-determined amount of time between receipt of a message and initiation of an action in response to that massage. This time may be dependent upon which channel the message was received on. The slave nodes may be configured to wait a relatively long length of time if the message was received via a first channel and progressively shorter lengths of time if the message was received via a second or subsequent channel. Conveniently, the slave node may be configured such that the waiting time in each case expires at the same point in time so the action is always initiated at the same start time (i.e. relative to the time of transmission of the message over the first channel).

Accordingly, each slave node may be capable of initiating an action at a predetermined time irrespective of which channel it received a message transmission from.

The wait time is conveniently determined by a count register configured to count down from a pre-determined number and wherein a register underflow results in the generation of a clock ‘tick’ to initiate an action such as an Interrupt Service Routine (ISR).

In certain embodiments, the receipt of a message on a slave node may drive a task scheduler on that node.

The above aspects of the present invention can advantageously be employed in a CAN-based system to maximise the reliability of the system. In which case, automatic re-sending of a failed message is disabled to prevent duplicate messages being sent on the same communication channel. Accordingly, single-shot transmission is enforced on each channel.

The above aspects of the present invention can also be employed advantageously in time-triggered systems.

According to a third aspect of the present invention there is provided an apparatus, machine or vehicle employing a distributed system according to the first aspect of the present invention.

As described above, embodiments of the present invention can be used to maintain clock accuracy across a distributed system, both under normal operating conditions and in the presence of faults in one or more of the communication channels.

### BRIEF DESCRIPTION OF THE SEVERAL VIEWS OF THE DRAWINGS

Particular embodiments of the present invention will now be described with reference to the accompanying drawings, in which:

FIG. 1 illustrates broadcast bus architecture, as employed in a distributed system according to the present invention;

FIG. 2 illustrates a TDMA message structure, as employed in a distributed system according to the present invention;

FIG. 3 illustrates a message transmission procedure, as employed in a distributed system according to the present invention;

FIG. 4 illustrates a message reception procedure, as employed in a distributed system according to the present invention;

FIG. 5 illustrates a message handling procedure, as employed in a distributed system according to the present invention;

FIG. 6 illustrates a fault injection technique employed to assess the effectiveness of a distributed system according to the present invention.

FIG. 7 illustrates the simple interface electronics that may be required at the node/bus interface of a distributed system according to the present invention.

### DETAILED DESCRIPTION OF THE INVENTION

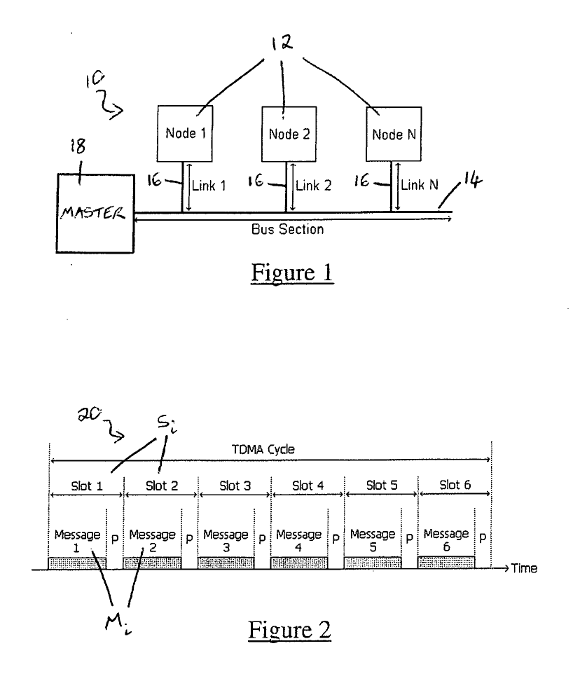

FIG. 1 illustrates a broadcast bus architecture 10 as employed in the present invention. Thus, a number N of slave nodes 12 are connected to a common bus 14 via a respective link 16 such that each node 12 can see all of the information on the bus 14. A master node 18 is provided at the head of the bus 14 and directs traffic over the bus 14 to the nodes 12.

This particular embodiment of the invention is configured for time-triggered applications and so each node 12 includes a clock that is synchronized to a global time-base (i.e. to a clock on the master node 18) with a guaranteed minimum level of accuracy ε. This is achieved by a (time master) node 18 in possession of an accurate timer, sending a periodic transmission of a time reference message over the network. This reference message, when received by the remaining (slave) nodes 12, invokes a high-priority interrupt, which is used for time-synchronization. Such clock-synchronization across the network ensures that message collisions on the bus 14 are prevented.

Task executions on each distributed node 12 are synchronized to the global time-base and scheduled such that message-handling tasks cannot be blocked or interrupted (i.e. they have the highest priority).

Each node 12 is also provided with a local timer that is independent of the global time-base, yet has the same accuracy.

Furthermore, each node 12 in the distributed system possesses a TDMA bus access schedule 20 for the network, as illustrated in FIG. 2. Accordingly, each node 12 is allocated a timeslot Sᵢ in the TDMA message cycle 20 which it can use for communication over the network. As shown, each timeslot Sᵢ is large enough to allow the worst-case transmission time Mᵢ of a message i (taking into account the accuracy of clock synchronization ε), plus an arbitrary inter-message idle period P. Each node 12 may be configured to transmit/receive messages in more allocated timeslot Sᵢ.

In this particular embodiment we describe an implementation of the present invention where each node 12 and the master node 18 employs the full CAN 2.0B protocol. However, in order to obtain the most benefit from the present invention, the nodes 12, 18 are prevented from entering the ‘error-passive’ state. A standard CAN controller issues a signal when a certain error count has been reached. In this embodiment, the error count is set to a level just before the node becomes ‘error passive’, and when issued, the controller is put into the ‘bus-off’ state by the application. Periodic attempts are then performed to reset the controller and enter the ‘error-active’ state.

In addition, it is convenient for automatic re-transmission of CAN messages to be disabled. This is because, with the present invention, as with any time-triggered system, automatic re-transmission of messages may cause other messages to miss their deadlines in a domino-like effect. A ‘fail-silent’ approach to message errors is therefore more appropriate. Moreover, since many sampled-data designs are robust to the loss of a single sample, the single-shot transmission approach may be particularly appropriate in such systems.

In accordance with the present invention, a number j of replicated communication channels similar to broadcast bus 14 are provided. The replicated communication channels are conveniently electrically isolated from each other, up to the controller level, and the cabling media used spatially routed via different physical paths.

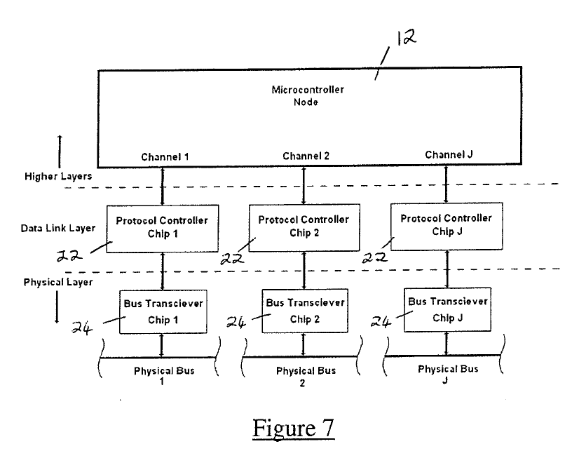

In order to minimize costs in the present invention, the use of simple interface electronics (based on non-proprietary solutions) are employed. Such electronics comprise off-the-shelf protocol controllers 22 and bus transceivers 24, as shown in FIG. 7.

Additional strategies may be employed to provide appropriate levels of node redundancy at the hardware level. For this embodiment, we will assume that each system node 12 employs fail-operational behaviour, and permanent node failures are not considered further.

Each communication channel C (in a j-channel system) will be referred to as follows: C₁, C₂, C₃, . . . Cⱼ. In order to manage each channel effectively when transmitting a particular message Mᵢ, an exact replica of it is sent over each network channel, but each message will be delayed by a short time period D from the previous message.

When a transmitting node (i.e. master node 18) enters the uninterruptible message transmit function, the message objects in each channel are first loaded with the required information (data fields etc.). Transmission of the message on channel C₁ is then initiated by setting that channel's Transmit Request (TXRQ) bit.

In order to strictly enforce ‘fail-silence’ and prevent undue jitter, single-shot transmission of each message in each channel is employed. A number of modern standalone or integrated CAN controllers now support ‘single shot’ transmission of messages at the hardware level; for example the Philips SJA1000, Microchip MCP2515 and the XC167 microcontroller on-chip CAN module. However, many existing systems operate using hardware without such support. To avoid restricting the application of the present invention to systems that do support single shot transmission, the presence of hardware support for single-shot transmission has not been assumed in this embodiment.

Consequently, the properties of the TDMA protocol have been exploited in the CAN controllers on each node 12 to ensure that such single-shot messaging takes place. Normally, a CAN controller will automatically queue a message for re-transmission after an error (or loss of arbitration) only if the TXRQ bit of the corresponding CAN controller object remains set. It is also the case that a standard CAN controller will reset the transmission object's New Data flag (NEWDAT) only if it has detected an idle bus and commenced the transmission procedure. This allows for a simple mechanism to ensure single-shot transmissions take place, since the bus should always be in the idle state when commencing a transmission. If, as the result of an error, the bus is not in the idle state then waiting for a NEWDAT reset may cause an unnecessary delay. To prevent this being a potential failure point, a short timeout T is introduced. Setting T to a value of 2 bit times (i.e. 2 μs at the maximum CAN bit rate) has been found to be sufficient for most applications.

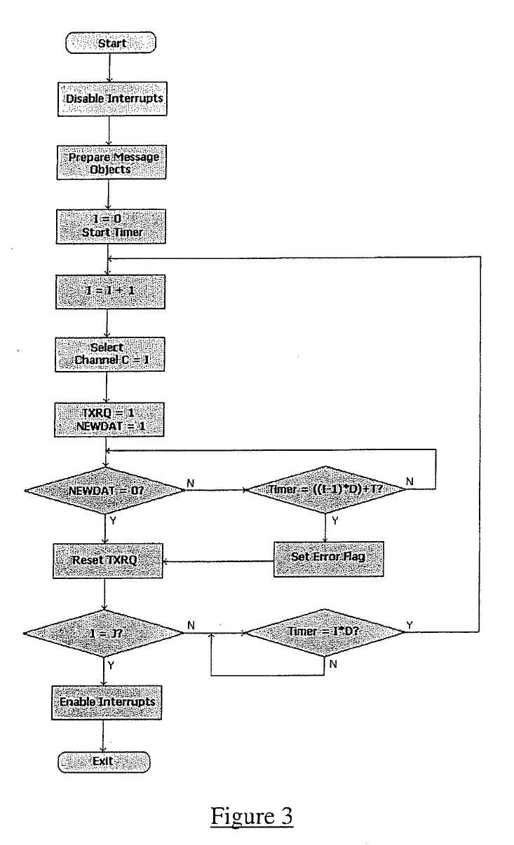

Thus, the following procedure is applied, as illustrated in the flow chart of FIG. 3. As soon as a message transmission has been initiated, a local on-chip timer is started and the status of the NEWDAT bit is monitored. Should this bit be set before T has elapsed, the transmission has been initiated; otherwise it has failed, and an appropriate error flag can be set. In either case, TXRQ is immediately reset to ensure that the message is not re-transmitted. We then wait until the time delay D has elapsed: D can be set to any value which satisfies the condition D>T. The Applicants have found that a value of D equal to 5 bit times is normally a sufficient level of delay. Transmission of the message on channel C₂ is then initiated by setting the TXRQ bit and using the same procedure detailed above to monitor the NEWDAT bit until a time period D+T has elapsed and an error flag has been set to the appropriate status. This procedure is repeated until the message transmission has been attempted on all j channels. The procedure can then terminate.

With such an approach, the redundant channel(s) all carry identical traffic, shifted slightly in time. The replica-determinism of the channels holds, and all transient errors (except babbling idiot errors) can be detected by checking for the absence of messages in each channel (by receiver nodes), or checking the transmit error status of all channels (for transmitters) after any given time-slot. The nodes 12 can achieve consensus on the status of the last transmission within the accuracy of the global clocks ε. Under normal, fault-free conditions, the receivers can also check the integrity of the received data by a majority vote or other suitable means.

On the slave nodes 12, each CAN controller is configured such that the arrival of the required message Mᵢ on any of the available channels (C₁, C₂ . . . Cⱼ) will invoke a high-priority interrupt. However, the interrupts are prioritised such that C₁>C₂> . . . >Cⱼ. An Interrupt Service Routine (ISR) corresponding to the message arrival is configured to perform some action such as scheduling a task for execution or clock synchronization. For the embodiment described, the worst-case execution time of the ISR W is known.

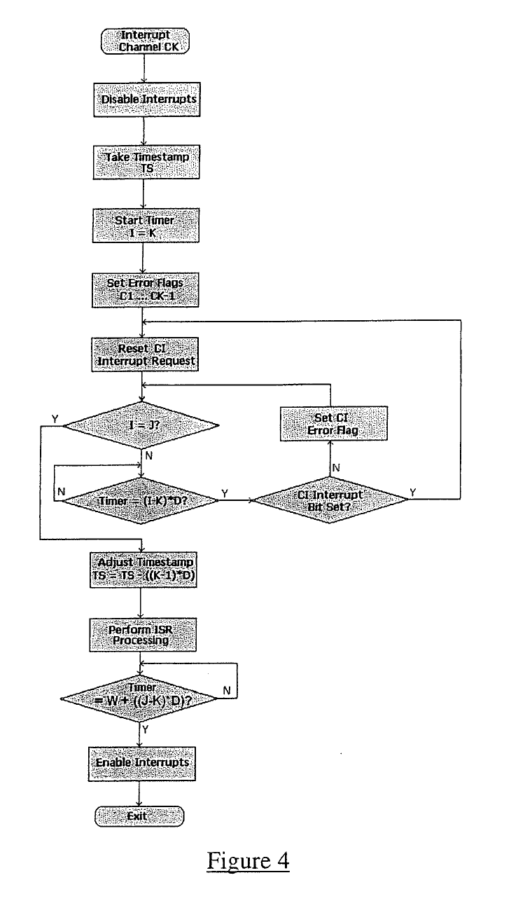

A summary of the message-reception procedure is shown in FIG. 4. Thus, message-reception is handled as follows: upon activation of a message interrupt via the channel Cₖ, the receiver will first disable all other interrupts, and timestamp the actuation of the message interrupt. A local timer is then started, and for all subsequent channels i=(k+1) to j, and at fixed intervals of time equal to (i*D), we manually ‘sample’ the interrupt request bit of CAN controller Cᵢ to check for reception of a valid message. Upon receipt of a valid message on Cᵢ, the resulting interrupt request bit for Cᵢ is reset. Missing messages can be flagged with an appropriate error, and all channels 1 to k−1 can also thus be flagged in the event of errors (unless k=1).

When this process is complete, the timestamp TS value is adjusted by subtracting a value (k−1)*D. This ensures that, regardless of the channel Cₖ that actually invoked the interrupt, the timestamp is adjusted such that its value represents the value that the first channel C₁ would have read. In this way we ensure that fault-tolerant time-stamping takes place.

The final processing that needs to take place as part of this redundancy management scheme is to ensure that the interrupt overheads terminate at the same point in time, regardless of the channel that invoked the interrupt. So, after the activation of an interrupt on channel Cₖ and the subsequent execution of ISR overheads (such as a synchronization algorithm), we wait for the timer to count to a value equal to W+((j-k)*D). This is a form of ‘sandwich delay’ and ensures that control is passed back to the scheduler at the same instant in time, regardless of the invoking channel.

The implementation of the message transmission, and reception processes, outlined above, is suitable for use with many software-based clock synchronization mechanisms. However, greater levels of clock synchronization will lead to significantly better performance, and better task synchronization in the distributed system.

Several factors may affect the accuracy of CAN-based clock synchronization methods, not least the bit-stuffing mechanism employed in CAN. For example, previous analysis of the shared-clock protocol has revealed that the jitter, and hence clock accuracy ε, between the clocks in a standard shared-clock network is largely dependant on this mechanism. This bit-stuffing induced variation in transmission times can also indirectly affect clock accuracy in other methodologies (for example when time-stamping reference messages). A methodology known as ‘Software Bit Stuffing’ has been developed to significantly reduce these variations and may be employed in embodiments of the present invention to help to increase clock accuracy.

In addition, during system power-up or after a block of continuous interference, there will be a time when individual nodes 12 will not have synchronized clocks. Each-node 12 should not transmit any messages (unless it is the time master) during this time. Since the choice of synchronization algorithm has an influence on the time taken to re-synchronize the clock, this should be made with care; the synchronization time should be several magnitudes smaller than the controllability time of the physical system.

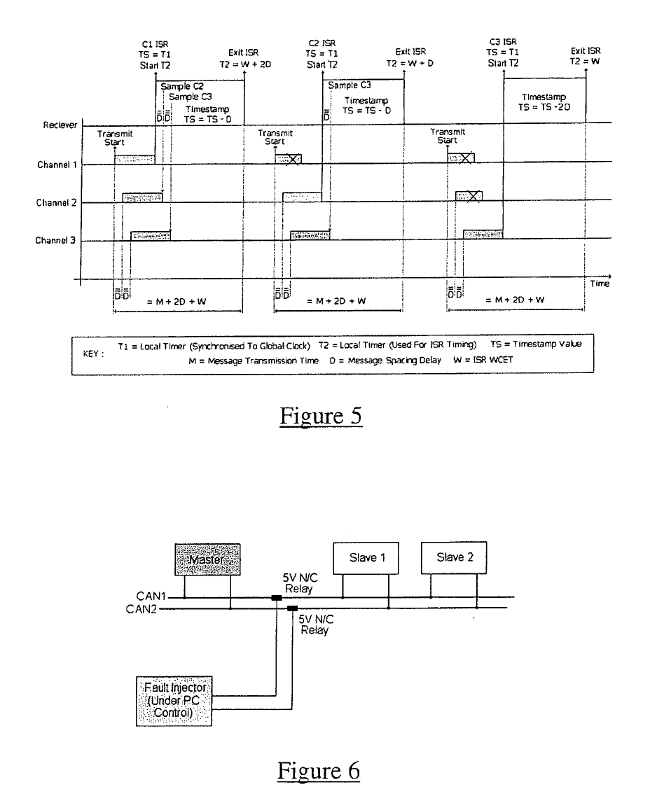

FIG. 5 shows an example of operation of a distribution system according to the present invention, illustrating the transmission and reception of a time-stamped message M, over a triple bus system (j=3), in three different fault scenarios.

In the first case illustrated, the receiving node correctly receives all messages on all channels. Accordingly, the ISR is initiated by the message received on channel 1 since this arrives first. The timestamp TS is therefore simply the actual time of the global clock T1 when the message is received (i.e. no adjustment is required). As the local timer T2 is started upon receipt of the first message, the time allowed before exiting the ISR is W+2D. This is so that, if the initiating message was the last message sent (i.e. that of channel 3 sent a time equal to 2D later), enough time would be allowed for the ISR to complete it's task before the ISR is exited.

In the second case illustrated, the receiving node does not correctly receive the message on channel 1 but does correctly receive the messages on channels 2 and 3. Accordingly, the ISR is initiated by the message received on channel 2 since this arrives first. The timestamp TS in this case is therefore calculated as the time of the global clock T1 when the message was received, minus D. As the local timer T2 is started upon receipt of the message from channel 2, the time allowed before exiting the ISR is W+D.

In the third case illustrated, the receiving node does not correctly receive the messages on channels 1 or 2 but does correctly receive the message on channel 3. Accordingly, the ISR is initiated by the message received on channel 3 since this arrives first. The timestamp TS in this case is therefore calculated as the time of the global clock T1 when the message was received, minus 2D. As the local timer T2 is started upon receipt of the message from channel 3, the time allowed before exiting the ISR is W.

Thus, from FIG. 5 it can be seen that regardless of the fault status of the underlying channels, the time taken from the start of transmission to the end of the receiver node ISR is substantially the same, and that the timestamp is dynamically adjusted to read approximately the same value in each situation. The impact of the above technique on the accuracy of these values is dependant on the implementation platform although any variation is likely to be very small. Consequently, any subsequent task release or synchronization associated with the arrival of a message is not subject to significant errors or jitter, and the triple-channel system appears as a single entity to both transmitters and receivers.

Having described the transmission and reception procedures associated with the present invention, a technique that allows the determination of the minimum values for each slot time Sᵢ in the TDMA cycle will now be described.

From FIG. 2, it can be seen that each slot Sᵢ consists of the message transmission time Mᵢ and the inter-message spacing period P. The idle period P should have a minimum value of 2ε, to compensate for synchronization errors in the global clock and to prevent message collisions. From a knowledge of the CAN protocol, it is possible to infer that the maximum transmission time (Cₘ) for a message with DLC (data length code) number of data bytes, including the worst-case level of bit stuffing, is given by Equation 1:

$${C}_{m} = ( ( 8 \cdot DLC ) + g + 13 + [ \frac{( 8 \cdot DLC ) + g - 1}{4} ] ) \cdot {τ}_{b} \qquad ( 1 )$$

where τ_{b} the bit-time and g is a constant representing control bits subjected to bit stuffing, and takes the value 34 for a standard CAN frame and 54 for an extended CAN frame.

Please note that this measure does not include any allowance for superposition of error frames or overload frames: we must include an extra 20 bits into this measure to cover these possibilities. In addition, in each transmission we have (j−1) copies of the message, each delayed by a time D. Taking these factors into consideration, the minimum slot time Sᵢ for a message transmission Mᵢ with a data length of DLCᵢ in a system with j replicated channels is given by Equation 2.

$${S}_{i MIN} = ( ( j - 1 ) \cdot D ) + ( 2 \cdot ɛ ) + [ ( ( 8 \cdot {DLC}_{i} ) + g + 13 + [ \frac{( 8 \cdot {DLC}_{i} ) + g - 1}{4} ] + 20 ) \cdot {τ}_{b} ] \qquad ( 2 )$$

Considering the simple architecture of FIG. 1, we can analytically determine the overall system failure rate for the communication equipment and physical media (CAN controller, bus transceivers, bus links, bus section) for a three node system (note: the failure rate for each node is not considered in this analysis). The findings are summarized in Table 1 below.

TABLE 1
Overall failure rate in multiple channel systems

| Number of | |
|---|---|
| Channels | Failures/Hour |
| 1 | 1.0 × 10⁻⁵ |
| 2 | 1.0 × 10⁻¹¹ |
| 3 | 1.0 × 10⁻¹⁷ |

From this table, it can be seen that increasing the number of channels has a very significant impact on the reliability of the communications equipment in the system. The increases are such that even the dual-channel system may be used in systems with high reliability requirements.

Clearly, unless there is large physical separation between the isolated channels, continuous blocks of electrical interference will affect all channels uniformly. However, we can assume for the purposes of analysis that any blocks of interference will be of limited duration. Since re-transmission is disabled, old messages lost to interference will no longer be re-transmitted and further (domino) disruptions are thereby avoided. In this way (without any further processing) the effects of certain types of transient errors can be minimised. In addition, as electrical and physical isolation is assumed, certain types of transient errors (such as intermittent connector faults associated with vibration) will be isolated and their effects will not propagate between channels. As such, the effects of inconsistent deliveries will be reduced in embodiments of the present invention.

It is possible to provide a quantitative estimate of the system's resilience to Inconsistent Message Omissions (IMO's), using a probability model. Since the re-transmission of messages is inhibited, the probability of Inconsistent Message Duplicates (IMD's) is zero. Also, given that each message is replicated over j different channels, the probability of an IMO for any particular message (of length DATA) is given by Equation 3, where BER is the bit error rate.

PIFO=((1−BER)^{DATA-2}.BER)^{j} (3)

Since an IMO may lead to a potentially dangerous system state, it is desirable to calculate the probability of such occurrences per hour. Considering each message in the time-triggered system as a periodic stream, a frequency (in terms of messages/second) fᵢ can be determined for each message i. This can be obtained from knowledge of the TDMA schedule and its period in seconds, T_{period}. The failure rate λ for a given system implementation with n streams may then be predicted using Equation 4 below.

$${λ}_{IMO} = {\sum }_{i = 1}^{n} 3600 \cdot {f}_{i} \cdot {PIFO}_{i} \qquad ( 4 )$$

Taking (for example) a system with T_{Period} equal to 0.01 seconds with a TDMA cycle of 9 messages each of length 110 bits (utilization≅80% at 125,000 bits/s), λ may be calculated for varying BERs as shown in Table 2 below.

TABLE 2
IMO failure rate in multiple channel systems

| Number of | Failures/Hour | | |
|---|---|---|---|
| Channels | BER = 10⁻⁷ | BER = 10⁻⁹ | BER = 10⁻¹¹ |
| 1 | 3.2 × 10⁻¹ | 3.2 × 10⁻³ | 3.2 × 10⁻⁵ |
| 2 | 3.2 × 10⁻⁸ | 3.2 × 10⁻¹² | 3.6 × 10⁻¹⁶ |
| 3 | 3.2 × 10⁻¹⁵ | 3.2 × 10⁻²¹ | 3.6 × 10⁻²⁷ |

From this table, it can be seen that increasing the number of channels from the single channel case dramatically reduces the failure rate of undetected IMOs. Prospective designers can thus estimate the likely safety impact of using the present invention with a particular message schedule in a particular environment.

The impact of IMOs in a time triggered system is in many cases not as critical as in an event triggered system. If messages are only sent in response to external events, the occurrence of an IMO can potentially result in a situation (which persists indefinitely) where the distributed system's knowledge of its external environment (and hence its internal state) is inconsistent, a potentially dangerous situation. This may not be the case for a time-triggered system.

Each message stream may be classified as containing either absolute (e.g. temperature) or incremental (e.g. change in temperature) data, and each message stream can also be classified in terms of its safety criticality. We also note that a system inconsistency after an IMO may only exist for a maximum of T_{period} in an absolute stream; as mentioned, a well-designed system can often tolerate the loss of a single sample without problems. However, in an incremental stream, the same potential problem exists whereby an inconsistency may persist for an indefinite, possibly dangerous time.

The number of IMO failures per hour may be calculated for individual message streams. If cost constraints dictate that (for example) a minimum number of channels must be used, further action can be taken to increase safety for critical messages, by duplicating the same data temporally as well as spatially. Techniques for designing a message schedule where critical streams are temporally duplicated are known. Thus the IMO failure rate for a particular message stream i duplicated r times in a j channel system may be calculated using Equation 5.

λ_{IMO}_{ᵢ}=3600·fᵢ·(PIFOᵢ)^{r} (5)

Thus even in a dual-channel system critical message streams may be designed to very high reliability requirements, whilst also exhibiting tolerance to permanent hardware faults in the replicated communication system.

The Applicants have also considered the impact that the present invention has on the overall message latency and channel utilization.

The latency (i.e. response/transmission time) of a message broadcast is bounded and kept approximately constant in time-triggered systems. The worst-case transmission time of a CAN message was given in Equation 1. As previously mentioned, in each transmission we have (j−1) copies of the message, each delayed by a time D: thus the overall increase in latency when adding additional busses is a period equal to (j−1)*D.

For example, if D is set to a value of 5 bit-times (a value which has been found to be effective), this corresponds to an increase of approximately 3% in maximum latency (per channel) when using 8 data bytes and extended identifiers.

Channel utilisation is a measure of how much of the total bus capacity is actually used, and ranges from 0% (no capacity used) to 100% (full capacity used). In order to enable a meaningful comparison of the effects of using the above broadcast technique, the Applicants have considered the effects of adding extra channels to a system using the single-bus case as a benchmark.

For a time-triggered bus, with n slots in the TDMA period, utilisation U can be defined as:

$$U = ( \frac{{\sum }_{i = 1}^{n} {M}_{i}}{{T}_{Period}} ) \cdot 100 \qquad ( 6 )$$

where Mᵢ is the actual transmission time of message i and T_{Period} is defined as:

$${T}_{Period} = ( {\sum }_{i = 1}^{n} {S}_{i} ) + {T}_{Idle} \qquad ( 7 )$$

where T_{Idle} is an inter-cycle ‘idle-time’ (i.e. a time period when the bus is idle between subsequent TDMA cycles), and Sᵢ is the slot time for each message i in the TDMA period (with a minimum duration defined by Equation 2).

Thus the channel utilisation depends on the nature of the message schedule, the accuracy of the clocks ε, the number of channels j and the idle period.

By way of example we shall consider the impact of using redundant channels, at various levels of clock accuracy, on a 1 Mbit/s system with no idle period, transmitting periodic messages with 8 data bytes and using extended identifiers. A table of utilisation U and slot size S for such a system is shown in Table 3. From this, we can see that the maximum possible bus utilisation for the TDMA strategy we have chosen, at maximum clock accuracy and bit rate, is 87% (if, however, we do not allow 20 bit times for error containment, the utilisation increases to 97.6%). As we add additional busses into the system, the maximum utilisation of each individual bus remains at this level, but—considering the channels as a single entity—the maximum utilisation starts to decrease, and the minimum achievable slot size increases by a value D for each extra channel. In all, the impact of redundant channels on the achievable bus utilisation and minimum latency times is minimal.

TABLE 3
Network channel utilization (1000 Kbits/sec)

| | ε (μs) | | | | | |
|---|---|---|---|---|---|---|
| Number of | 2 | | 10 | | 100 | |
| Channels | U (%) | S (μs) | U (%) | S (μs) | U (%) | S (μs) |
| 1 | 87 | 184 | 80 | 200 | 42.1 | 380 |
| 2 | 84.7 | 189 | 78.1 | 205 | 41.6 | 385 |
| 3 | 82.5 | 194 | 76.2 | 210 | 41.1 | 390 |

Despite the fact that the impact of redundant channels is minimal, it can be seen from Table 3 that the bus utilisation in the system decreases dramatically as the level of clock accuracy decreases. This is because the required slot size S is highly dependant on the level of accuracy, and a larger idle period P is required at lower levels of accuracy. However, as the bit rate decreases the impact of clock accuracy also decreases. If we repeat the previous exercise for a 125 Kbits/s system (Table 4), it can be seen that the overall levels of utilisation increase, even at a clock accuracy of 100 μs.

TABLE 4
Network channel utilization (125 Kbits/sec)

| | ε (μs) | | | | | |
|---|---|---|---|---|---|---|
| Number of | 2 | | 10 | | 100 | |
| Channels | U (%) | S (μs) | U (%) | S (μs) | U (%) | S (μs) |
| 1 | 88.7 | 1446 | 87.7 | 1462 | 78.1 | 1642 |
| 2 | 88.4 | 1451 | 87.4 | 1467 | 77.8 | 1647 |
| 3 | 88 | 1456 | 87.1 | 1472 | 77.6 | 1652 |

In fact, if we can constrain the maximum error in the clocks to a value ε≦10.ε_{b} (the bus bit-time), the achievable bus utilisation (even in systems with 6 channels) can be maintained at around 80%: this is higher than that achievable through the use of some standard (arbitrating) approaches.

Overall, as the above analysis demonstrates, the present invention allows for the timely delivery of all messages at high bus utilisation levels, and a graceful degradation in the presence of both transient and permanent errors in the communication channels. Given the nature of these results, a dual-channel system may provide an optimal trade-off between reliability, bus utilisation and cost for many systems.

As can be seen for the description and analysis of the present invention, the success of this particular embodiment relies on the ability to maintain clock accuracy ε under normal operating conditions, and also in the presence of channel faults. The following details a simple case study that the Applicants undertook to illustrate the effectiveness of the present invention using a simple three-node test system employing a dual-channel architecture. All nodes in this test system were implemented using 16-bit Infineon C167CS microcontrollers which incorporate dual CAN controllers.

For this case study, a variant of a shared-clock scheduler was employed. In this type of distributed embedded system, one accurate clock is used to drive the scheduler of a Master node, which sends periodic Tick messages across the CAN bus. The Slave nodes have schedulers that are driven by the arrival of these Tick messages; essentially only a single valid ‘Tick’ is required to synchronize the slave clocks. In this way, the activity on all the nodes in the system can be synchronized, and messages can be transmitted at specific time slots, employing a pre-defined TDMA schedule. Upon start-up (or following a continuous block of electrical interference), synchronisation of the distributed clocks takes approximately 300 μs in this system.

The bit rate employed in this study was 1 Mbit/s. With reference to FIG. 2, the TDMA cycle in this simple test case used 4 slots: the Master node first transmits an (empty) time-reference (‘Tick’) message. Following this, each node is then allotted a slot to transmit a single 8-byte message, containing (randomly generated) data. In each case, the length of the TDMA cycle (T_{Period}) was equal to 5 ms; each slot width was equal to 1 ms, giving an additional idle period of 1 ms. To execute the application software, each node in the system employed a hybrid scheduler: the single pre-empting task was used to handle the communication between nodes.

In order to measure the levels of clock synchronization, periodic tasks were created for both the Master and Slave nodes, with synchronous execution, once every 5 ms. At the start of the Master task, a port pin was set high (for a short period of time). In the Slaves, another pin (initially high) was set low at the start of the task, again for a short period. The signals from the Master pin and a Slave pin were then AND-ed (using a 74LS08N), to give a pulse stream. The widths of the resulting pulses was thus representative of the synchronization between the clocks, and were measured using a National Instruments data acquisition card ‘NI PCI-6035E’, used in conjunction with the LabVIEW 7.1 software package.

Clock jitter levels were determined by taking the difference of the maximum and minimum delays in the sample set and by calculating the variance of the sample set as an indication of the average. In each experiment, 10,000 samples were taken, for four different conditions covering intermittent and permanent channel failures:
Normal system operation (CAN1 and CAN2 OK).
Partial system operation (CAN1 faulted, CAN2 OK).
Partial system operation (CAN2 faulted, CAN1 OK).
Random faults on either CAN1 or CAN2 during the measurement period.

In order to inject the failures into each underlying channel, a fault injector was employed controlled by a separate PC. This setup is shown schematically in FIG. 6. The random faults were injected with an average inter-arrival of 1000 ms. All injected faults were cleared after 250 ms, allowing the relay contact plenty of time to operate.

The clock synchronization results obtained are shown in Table 5 (units of μs). From this table, it can be seen that a worst-case clock synchronization of ±1.125 μs could be guaranteed, with an average accuracy less than 0.6 μs, regardless of the fault status of the channels. Thus with this clock accuracy ε=2.25 μs, the constraint that ε≦10.τ_{b} is more than satisfied: the protocol can therefore be applied even at the highest bit rate.

In addition, it was noted that no data errors or missing samples were recorded during this period, indicating that all messages sent over healthy channels were delivered and processed correctly. These results indicate that, even in the presence of faults, no node in the network has lost its clock accuracy, and the TDMA schedule was maintained.

TABLE 5
Jitter measurements for fault scenarios (μs)

| Measurement | Normal | CAN1 Only | CAN2 Only | Random |
|---|---|---|---|---|
| Max | 2.42 | 2.75 | 2.70 | 2.55 |
| Min | 0.30 | 0.70 | 0.58 | 0.30 |
| Max − Min | 2.12 | 2.05 | 2.12 | 2.25 |
| Ave (Std) | 0.55 | 0.55 | 0.59 | 0.57 |

The present invention has therefore provided solutions to at least the first three problems of CAN, as highlighted in the introduction. Together these factors can be used to increase the reliability of CAN-based designs. Overall, it is believed that the present invention may be adapted to compliment, and potentially improve, the features of many of the numerous CAN-based protocols, which are already in existence, in addition to other types of protocols entirely.

As can be seen from the above example, the present invention supports highly deterministic message transfers and are robust to failures in the communication channels. It is also noted that, under fault-free circumstances, the redundancy management technique has a negligible impact on the system bandwidth, and provides clock synchronization levels that are robust to faults in any of the underlying channels. Finally, it is noted that the levels of clock synchronization over multiple channels that have been achieved by the above, exceed those currently demonstrated by the TT-CAN protocol. In addition, there is no practical reason why one (or more) of the slots in the static communication schedule cannot be designated for use as ‘arbitrated’ windows.

Furthermore, in the distributed system of the present invention as described above, the message broadcasts will be transparent to both producers and consumers and the replicated channels will appear as a single entity.

Embodiments of the present invention, like that described above, may comprise a method of synchronization to ensure that clocks (and, hence, tasks) on distributed nodes remain synchronized in the event of errors or failures in one or more of the underlying communication channels.

Accordingly, scalable, low-jitter systems with full channel redundancy can be implemented using standard CAN hardware. The techniques employed are particularly useful in resource-constrained, low-cost systems in which (i) low clock jitter and predictable behaviour are required; (ii) additional software and hardware must be kept to a minimum.

The techniques of the present invention support high levels of network utilisation, allowing designers to get high levels of performance from the CAN protocol. This makes the protocol suitable for a wide range of applications.

Although many protocols employ distributed clock synchronization algorithms, none employ a delayed transmission mechanism and dynamic adjustment of a time stamp, as described above. Consequently, the present invention provides an alternative distributed clock synchronization means with the above-mentioned advantages.

It will be appreciated by persons skilled in the art that various modifications may be made to the above-described embodiments without departing from the spirit and scope of the present invention. For example, whilst the above discussion has been primarily concerned with the CAN protocol, the invention is equally applicable to other protocols and standards such as UART-based RS-232 and RS-485 networks, and deterministic forms of the Ethernet protocol.

What is claimed is:

1. A distributed system comprising:
a master node;
at least one slave node; and
two or more communication channels linking the master node to the at least one slave node;
wherein the master node is configured for transmitting the same message to the at least one slave node over each of the two or more communication channels, with a pre-determined delay between each channel transmission.

2. A method of communication in a distributed system comprising the following steps:
(iv) transmitting a message from a master node to at least one slave node, over a first communication channel;
(v) after a pre-determined delay, transmitting the message from the master node to the at least one slave node, over a different communication channel; and
(vi) repeating step (ii) until the message has been sent over a pre-determined number of communication channels.
